(19) United States
(12) Patent Application Publication
(10) Pub. No.: US 2013/0246206 A1
(43) Pub. Date: Sep. 19, 2013

(54) METHOD AND ARRANGEMENT FOR PROVIDING A SERVICE

(71) Applicants: Vincent Huang, Sollentuna (SE); Simon Moritz, Stockholm (SE); Joakim Söderberg, Solna (SE)

(72) Inventors: Vincent Huang, Sollentuna (SE); Simon Moritz, Stockholm (SE); Joakim Söderberg, Solna (SE)

(73) Assignee: Telefonaktiebolaget L M Ericsson (publ), Stockholm (SE)

(21) Appl. No.: 13/989,327

(22) PCT Filed: Nov. 25, 2010
(86) PCT No.: PCT/SE10/51300

§ 371 Date: May 23, 2013

(51) Int. Cl. G06Q 30/06

(52) U.S. Cl. CPC G06Q 30/0601
USPC 705/26.1

(57) ABSTRACT

A method in a Service agent, a Service Agent and a computer-readable medium comprising a computer program are provided for providing a service to a user. The method comprises detecting connection of a Personal Profile Device, operated by the user, to the Service Agent. The method further comprises receiving a service information message from a Service Provider, comprising a service identifier, and obtaining a service profile from the Personal Profile Device using the service identifier. The method further comprises logging in to at least one Information Source identified from the service profile using personal credentials comprised in the service profile in order to allow the Service Provider to access the information needed for providing the service and requesting the Service Provider to set up a connection to the at least one Information Source and to obtain the information needed for providing the service. Thereby, delivery of the service from the Service Provider to a Service Endpoint, which is operatively connected to the Service Agent, based on the information is enabled

### TECHNICAL FIELD

The invention relates generally to a method and an arrangement for providing a service to a user. The present invention relates in particular to a method and an arrangement for providing a service to a user, wherein information needed to deliver the service is distributed.

### BACKGROUND

The use of Internet is constantly increasing and new Internet services are constantly being introduced. Many services require a user to log in to a service provider in order to gain access to the service that is offered. Many services require personal information or user information in order to provide the service. This way, user information is distributed across the Internet at different locations.

When a user is presented with a service from a service provider, the service is usually presented to the user in a way that is dependent on the service provider. Lately, many service providers enable the user to customize the service or at least the presentation of the service. Some services also make use of the user's consumption history in order to customize the service for the user.

Merely as an example, assume a user frequently shops at an Internet online store, this store being an aforementioned service provider. The user's shopping history may be used in order to suggest other items of possible interest to the user. The suggested items are then somehow “related” to the previously purchased items by the user. If a user has bought, e.g. many romantic novels, then a newly available romantic novel at the online store may be suggested to the user as it may be of interest to the user.

Some services make use of a user profile, in such a way that a user's preferences for a particular service are considered when providing or offering the service to the user. As an example, a user may be given the possibility to enter personal information that can be used by the service provider to customize the service for the user.

As a consequence, user information may be stored at many different locations across the Internet, although being confined to each service provider or the like. Personal information, or user information, can be sensitive and it may be desirable to confine the personal information to each service provider. At least it is desirable to a user to be in control over his/her personal information and over which parties that have access thereto. It may also be desirable to the different service providers to be in control of the personal information. One example of service providers who are very careful with their users' information is banking enterprises.

It is a problem to enable a service provider to gain access to user information which is not stored within the service provider. It is further a problem to access all or some user information and to integrate user information from several different sources with different sign-on methods or login methods.

### SUMMARY

It is an object of the invention to address at least some of the problems outlined above. In particular, it is an object of the invention to provide a method and an arrangement for providing a service to a user, with as little interaction as possible from the user in order to provide the service.

These objects and others may be obtained by providing a method in a Service agent and a Service agent.

According to an aspect, a method in a Service Agent for providing a service to a user is provided. The method comprises detecting connection of a Personal Profile Device, operated by the user, to the Service Agent. The method further comprises receiving a service information message from a Service Provider, comprising a service identifier, and obtaining a service profile from the Personal Profile Device using the service identifier. The method further comprises logging in to at least one Information Source identified from the service profile using personal credentials comprised in the service profile in order to allow the Service Provider to access the information needed for providing the service and requesting the Service Provider to set up a connection to the at least one Information Source and to obtain the information needed for providing the service. Thereby, delivery of the service from the Service Provider to a Service Endpoint, which is operatively connected to the Service Agent, based on the information is enabled.

This has several advantages. A user can be in full control of his/her personal information and still enable service providers to obtain user information from one single or several different information sources. The user may specify a service profile valid for a particular service, which profile defines which information sources can be accessed to obtain user information. The service profile may also comprise login or sign-in information so that the access to the information sources can be performed automatically without intervention or interaction by the user. Another advantage is that a service can be personalized or customized for the user as he/she may enable the service provider to access a large amount of information from many different information sources. The more information that can be obtained by the service provider, the more personalized or customized the service can be made.

Further, cloud computing systems are emerging and with them come the risks using them. An individual user would like to access his/her personal content but would in the time need a more secured way of accessing this personal content This can be achieved by this method.

According to an embodiment, the method further comprises retrieving personal settings from the Personal Profile Device to enable presentation of the service via the Service Endpoint in accordance with the personal settings.

This has the advantage that a user may personalize the presentation of a service so that it is presented to the user in the same manner regardless of the Service Endpoint that is being used to deliver the service.

According to an embodiment, the method further comprises detecting disconnection of the Personal Profile Device from the Service Agent, wherein the method further comprises requesting the Service Provider to terminate all connections set up between the Service Agent, the Service Provider and the at least one Information Source in association with the delivery of the requested service and to delete all personal information associated with the delivered service in the Service Provider. The method comprises logging out from the at least one Information Source, and deleting all personal information associated with the delivered service in the Service Agent.

According to an embodiment the method further comprises receiving a service termination message from the Service Provider, wherein the method further comprises requesting the Service Provider to terminate all connections setup between said Service Agent, the Service Provider and the at least one Information Source in association with the delivery of the requested service and to delete all personal information associated with the delivered service in the Service Provider. The method comprises logging out from the at least one Information Source, and deleting all personal information associated with the delivered service in the Service Agent.

According to an embodiment, the method further comprises receiving a service termination message from the Service Provider, wherein the method further comprises starting a timer, and; when the timer has lapsed, the method comprises requesting the Service Provider to terminate all connections set up between the Service Agent, the Service Provider and the at least one Information Source in association with the delivery of the requested service and to delete all personal information associated with the delivered service in the Service Provider. The method further comprises logging out from the at least one Information Source, and deleting all personal information associated with the delivered service in the Service Agent.

According to yet an embodiment, the method further comprises establishing a secure communication channel between the Personal Profile Device and the Service Agent after detection of the Personal Profile Device to the Service Agent.

According to yet an embodiment, the method further comprising issuing a temporary token in response to receiving the service information message and providing the token to the Service Provider when requesting the Service Provider to setup a connection to the at least one Information Source, thereby enabling, by means of the token, the Service Provider to obtain the information needed for providing the service.

According to an aspect a Service Agent is provided which is adapted to provide a service for a user. The Service Agent comprises a detecting unit adapted to detect connection of a Personal Profile Device, operated by the user, to the Service Agent. The Service Agent further comprises a communication unit adapted to receive a service information message from a Service Provider, comprising a service identifier. Further, the Service Agent comprises a processing unit adapted to, via the communication unit obtain a service profile from the Personal Profile Device, using the service identifier and to log into at least one Information Source identified from the service profile using personal credentials comprised in the service profile in order to allow said Service Provider to access the information needed for providing the service; and to request the Service Provider to set up a connection to the at least one Information Source to obtain the information needed for providing the service. Thereby, delivery of the service from the Service Provider to a Service Endpoint, which is operatively connected to the Service Agent, based on the information is enabled.

According to an embodiment, the processing unit is further adapted to retrieve personal settings from the Personal Profile Device to enable presentation of the service via the Service Endpoint in accordance with the personal settings.

According to an embodiment, the detecting unit is further adapted to detect disconnection of the Personal Profile Device from the Service Agent, wherein the processing unit is further adapted to: request the Service Provider to terminate all connections setup between the Service Agent, the Service Provider and the at least one Information Source in association with the delivery of the requested service; to delete all personal information associated with the delivered service in the Service Provider, to log out from the at least one Information Source, and to delete all personal information associated with the delivered service in the Service Agent.

According to yet an embodiment, the communication unit is further adapted to receive a service termination message from the Service Provider, wherein the processing unit is adapted to request the Service Provider to: terminate all connections setup between the Service Agent, the Service Provider and the at least one Information Source in association with the delivery of the requested service; to delete all personal information associated with the delivered service in the Service Provider; to log out from the at least one Information Source, and to delete all personal information associated with the delivered service in the Service Agent.

According to yet an embodiment, the communication unit is further adapted to receive a service termination message from the Service Provider, wherein the processing unit is adapted to start a timer, the processing unit further being adapted to detect the lapsing of the timer, wherein the processing unit is further adapted to request the Service Provider to: terminate all connections set up between the Service Agent, the Service Provider and the at least one Information Source in association with the delivery of the requested service; to delete all personal information associated with the delivered service in the Service Provider, to log out from the at least one Information Source, and to delete all personal information associated with the delivered service in the Service Agent.

According to an embodiment, the communication unit is adapted to establish a secure communication channel between the Personal Profile Device and the Service Agent after detection of the Personal Profile Device to the Service Agent.

According to an embodiment, the processing unit is further adapted to issue a temporary token in response to the reception of the service information message and to provide the token to said Service Provider when requesting the Service Provider to setup a connection to the at least one Information Source, thereby enabling the Service Provider, by means of the token, to obtain the information needed for providing the service.

According to an embodiment the Service Agent is incorporated into the Service Delivery Endpoint.

According to yet an aspect, a Service Endpoint is provided, wherein the Service Endpoint comprises a Service Agent.

According to yet an aspect, a computer-readable medium is provided the computer-readable medium comprising a computer program having program instructions stored thereon that are executable by a computer or processor of the Service Agent, to perform the method.

### BRIEF DESCRIPTION OF DRAWINGS

The invention will now be described in more detail by means of exemplary embodiments and with reference to the accompanying drawings, in which:

FIG. 1 is a flowchart of an embodiment of a method for providing a service for a user.

FIG. 2 is a flowchart of an exemplifying embodiment of a method for providing a service for a user, illustrating termination of the service.

FIG. 3 is a flowchart of an exemplifying embodiment of a method for providing a service for a user, illustrating termination of the service.

FIG. 4 is a flowchart of an exemplifying embodiment of a method for providing a service for a user, illustrating termination of the service.

FIG. 5 is a block diagram of an embodiment of a service agent adapted to provide a service for a user.

FIG. 6 is a signaling diagram illustrating an embodiment of an exemplary method for providing a service for a user.

FIG. 7 is a signaling diagram illustrating an embodiment of an exemplary method for providing a service for a user.

### DETAILED DESCRIPTION

In the following, a detailed description of some exemplary embodiments will be described.

Briefly described, a method and a Service Agent are provided for providing a service for a user

There are many ways to obtain information about a user. The user may himself herself enter personal information as to, e.g., his/her preferences, interests, metadata and so on. By monitoring and analyzing the behavior and consumption of a user, knowledge and information of the user may also be obtained. It is necessary to treat this information carefully and therefore it is of interest to a user to be in control of this information.

It is therefore desirable to be able in automatically create a user specific service environment A user is in possession of a Personal Profile Device, PPD. The PPD comprises a memory and means for being connected to another device as will be explained below. The memory of the PPD will comprise personal information such as user information, e.g. user identifiers. When the PPD is connected to another device, this device will be able to access the personal information stored in the memory of the PPD.

The memory of the PPD may also comprise user account credentials. These may be used to challenge the user of the device such that when activating the PPD, the user needs to enter a response in order to secure his/her identity.

The memory of the PPD may also comprise personal settings. The personal settings will enable the look and feel of a terminal, which is being used together with the PPD, to appear just as the user is familiar to. As an example, when the PPD is used together with a terminal having a display, the display will show a background in accordance with the personal settings, i.e. a personal background, even though the device is a shared device.

Further, the memory of the PPD may comprise one or more service profiles. A service profile is typically associated with a specific service. The service may be identified by a service type, a service ID or a service code. A service profile comprises identities of information sources which the service can access and credentials used to access the information source. A service may have more than one service profile, such that a user may choose which service profile he/she wishes to use. A service profile may be associated with more than one service.

The PPD may be comprised in a mobile telephone, a USB stick, a laptop or any other portable means or device. The PPD is connectable to a service agent, which in turn is coupled or connected to a service access device, also called a service endpoint. Alternatively, the service agent is incorporated with the service endpoint. In such a case, the PPD is coupled to the service agent by being connected to the service endpoint. The connection of the PPD to the service agent may be done by wire or wirelessly, by insertion, plug-in or any other suitable way. The service endpoint in turn may be e.g. a Set Top Box, a television set, a mobile telephone, computer, a personal digital assistant or a game console.

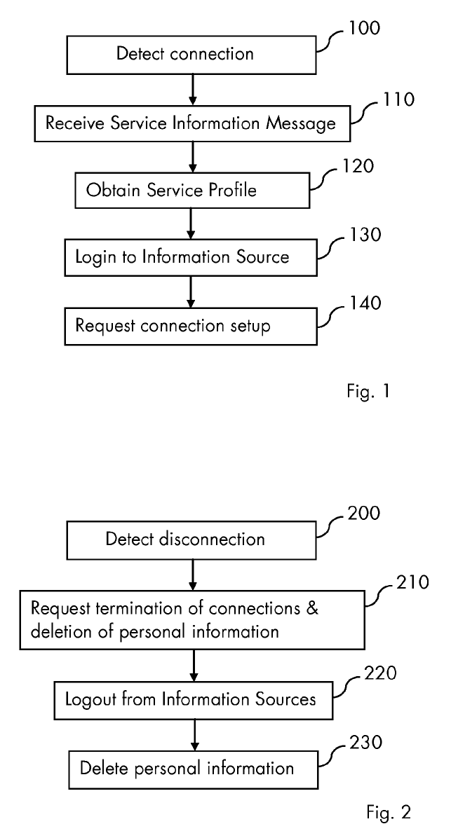

FIG. 1 is a flowchart of an embodiment of a method in a Service Agent for providing a service for a user.

FIG. 1 illustrates an exemplifying method for providing service to a user. The method is initiated as a user of a PPD connects the PPD to a Service Agent, for example by means of Bluetooth, insertion or plug-in. The method comprises the Service Agent detecting 100 connection of a PPD to the Service Agent. The PPD is operated by a user, as stated above. The method further comprises the Service Agent receiving 110 a service information message from a Service Provider, comprising a service identifier. Further, the method comprises obtaining 120 a service profile from the Personal Profile Device, using the service identifier. Then, logging in 130 to at least one Information Source identified from the service profile using personal credentials comprised in the service profile in order to allow said Service Provider to access the information needed for providing the service. The service profile may indicate a plurality of Information Sources. In such a case, the Service Agent may perform the login procedure 130 to each and every Information Source. Thereafter, the Service Agent requests 140 the Service Provider to setup a connection to the at least one Information Source and to obtain the information needed for providing the service. In the case of a plurality of Information Sources, the Service Agent may request 140 the Service Provider to setup a connection to each and every Information Source. In this way, the method in the Service Agent enables the delivery of the service from the Service Provider to a Service Endpoint, based on the information acquired from the at least one Information Source.

This has several advantages. A user can be in full control of his/her personal information and still enable service providers to obtain user information from one single or several different information sources. The user may specify a service profile valid for a particular service, which profile defines which information sources can be accessed to obtain user information. The service profile may also comprise login or sign-in information so that the access to the information sources can be performed automatically without intervention or interaction by the user. Another advantage is that a service can be personalized or customized for the user as he/she may enable the service provider to access a large amount of information from many different information sources. The more information that can be obtained by the service provider, the more personalized or customized the service can be made.

According to an embodiment, the method further comprises retrieving personal settings from the PDD to enable presentation of the service to the user in accordance with the personal settings.

This may be done, e.g. just after the Service Agent detects 100 connection of the PPD to the Service Agent. In one example, the Service Agent may request personal settings from the PPD and the PPD will return the personal settings to the Service Agent. The Service Agent will then forward the personal settings to the Service Endpoint. The Service Endpoint is then able to use the personal settings to present the service to the user in accordance with the personal settings.

According to yet an example, the PPD may comprise one or more user profile, wherein a user profile comprises personal settings as described above. In such a case, the Service Agent can retrieve a user profile comprising the personal settings. In case the PPD comprises several user profiles, the user may be presented with the different user profile and be given the opportunity to select which user profile he/she wishes to use. As the user selects a user profile to be used, the personal settings in the selected user profile are forwarded to the Service Endpoint

The personal settings could also be used, in another example, to present the services that are supported by the Service Endpoint in the same manner regardless of the Service Endpoint being used. The presentation of the supported services will look the same no matter which Service Endpoint is used. The Service Endpoint could be a shared one, at e.g. a hotel room or at a library, or a personal one at the home of the user.

According to an embodiment, the service identifier is a Service Type or a Service Code.

FIGS. 2-4 are flowcharts of different exemplifying embodiments of termination of the service, the service having been setup or established as described above with reference to FIG. 1. In the shown embodiments, all connections are terminated and all personal information associated with the delivered service in the Service Provider is deleted. Also, the Service Agent logs out from the at least one Information Source and deletes all personal information associated with the delivered service in the Service Agent. These steps are taken to ensure security and that the user is in control of his/her own personal information.

FIG. 2 illustrates the method comprising the Service Agent detecting 200 disconnection of the PPD from the Service Agent. The method further comprises the Service Agent requesting 210 the Service Provider to terminate all connections set up between said Service Agent, the Service Provider and the at least one

Information Source in association with the delivery of the requested service and to delete all personal information associated with the delivered service in the Service Provider, and logging out 220 from the at least one Information Source, deleting 230 all personal information associated with the delivered service in the Service Agent. Step 220 of course is repeated for each Information Source that the Service Agent has logged into. In case the Service Agent has ordered the Service Provider to setup connections to a plurality of Information Sources, the Service Agent may send one request 210 to the Service Provider to terminate the connection and to delete all personal information per Information Source as an alternative to sending one request 210 to the Service Provider requesting termination of all connections and deletion of all personal information associated with the delivered service in the Service Provider.

In this example, a disconnection of the PPD is interpreted such that the user no longer wishes to make use of the service. It should be possible to ensure that no connection is left established and that no personal information is stored in neither the Service Agent nor the Service Endpoint in order to protect the user's personal information. Especially if the user is using a shared Service Endpoint, it should be possible to ensure that another user may not in any way be given any personal information of the previous user. Therefore, all the connections that have been set up in association with the delivery of the service are terminated and all personal information associated with the delivered service is deleted in the Service Agent and in the Service Provider. This can be performed, e.g., by the Service Agent requesting the Service Provider to terminate all connections it has established and to delete all personal information it has acquired in association with the delivery of the service. The Service Agent itself terminates all connections it has set up and deletes all personal information it has acquired.

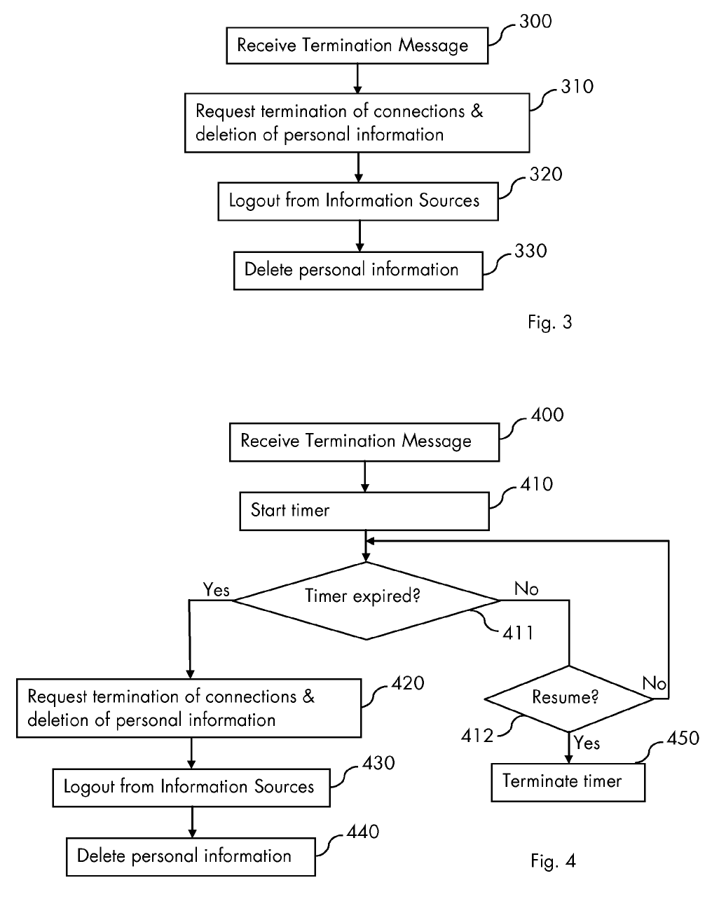

FIG. 3 is a flowchart of an exemplifying embodiment of a method for providing a service for a user, illustrating another embodiment for termination of the service previously setup according to the method described above with reference to FIG. 1.

As illustrated in FIG. 3, in this embodiment, the method comprises the Service Agent receiving 300 a service termination message from the Service Provider, wherein the method further comprises requesting 310 the Service Provider to terminate all connections setup between the Service Agent, the Service Provider and the at least one Information Source in association with the delivery of the requested service and to delete all personal information associated with the delivered service in the Service Provider, and logging out 320 from the at least one Information Source, deleting 330 all personal information associated with the delivered service in the Service Agent. Again, step 320 of course is repeated for each Information Source that the Service Agent has logged into. In case the Service Agent has ordered the Service Provider to setup connections to a plurality of Information Sources, the Service Agent may send one request 310 to the Service Provider to terminate the connection and to delete all personal information per Information Source as an alternative to sending one request 310 to the Service Provider requesting termination of all connections and deletion of all personal information associated with the delivered service in the Service Provider

In this example, the reception of a service termination message from the Service Provider is interpreted such that the user no longer wishes to make use of the service. It should be possible to ensure that no connection is left established and that no personal information is stored in order to protect the user's personal information. Especially if the user is using a shared Service Endpoint, it should be possible to ensure that another user may not in any way be given any personal information of the previous user. This is performed in the same manner as described above in relation to FIG. 2. Here the service will be delivered until the user wishes to stop making use of the service. As the user wants to stop making use of the service, he/she indicates this to the Service Provider. As the Service Provider receives the request for service termination, the Service Provider informs the Service Agent that the user no longer wishes to make use of the service. The Service Agent is then responsible for terminating all connections and deleting all personal information as has been described above.

FIG. 4 is a flowchart of yet an embodiment of how to terminate the service.

FIG. 4 illustrates the method comprising receiving 400 a service termination message from the Service Provider, wherein the method further comprises starting 410 a timer. When the timer is started, the Service Agent waits for the timer to expire or for the user to resume the service. In case the timer has not expired and the user resumes the service, the Service Agent terminates the timer 450. This is illustrated in FIG. 4 as the Service Agent checking 411 if the timer has expired and if it has not expired, the Service Agent checking 412 if the user has resumed the service. In case the timer expires before a user indicates that he/she wishes to resume the service, the method comprises requesting 420 the Service Provider to terminate all connections setup between the Service Agent, the Service Provider and the at least one Information Source in association with the delivery of the requested service and to delete all personal information associated with the delivered service in the Service Provider, and logging out 430 from the at least one Information Source, deleting 440 all personal information associated with the delivered service in the Service Agent.

In this example, the reception of a service termination message from the Service Provider is interpreted such that the user may possibly want to continue using the same service or another service in a short while. Therefore, a timer is started to delay the termination of the connections and the deletion of information in the Service Provider and in the Service Agent. If the user chooses to continue the service before the expiration of the timer, then the Service Provider may start delivering the service since all the necessary connections and user information is already ready and available. When the timer expires, it should be possible to ensure that no connection is left established and that no personal information is stored in order to protect the user's personal information. Especially if the user is using a shared Service Endpoint, it should be possible to ensure that another user may not in any way be given any personal information of the previous user. This is performed in the same manner as described above in relation to FIG. 2.

Further, in relation to FIG. 4, it is possible that the user wishes to make use of another service that could be delivered at the same Service Endpoint. In case this service is being delivered by a different Service Provider than the previously delivered service, then all connections setup between the Service Agent, the Service Provider and the at least one Information Source in association with the delivery of the requested service should be terminated and all personal information associated with the delivered service in the Service Provider should be deleted. However, the connections set up between the Service Agent and the at least one Information Source need not be terminated and the information acquired by the Service Agent need not be deleted. This is because the new Service Provider may make use of the same user information or parts of the same user information and may want to acquire user information from the same Information Source(s).

According in yet an embodiment, the method further comprising issuing a temporary token in response to receiving the service information message and providing the token to the Service Provider when requesting the Service Provider to setup a connection to the at least one Information Source, thereby enabling, by means of the token, the Service Provider to obtain the information needed for providing the service.

This may performed in order to enhance security. The Service Agent issues a temporary token which is valid for the duration of the service or for requesting information from the at least one Information Source once. The token is given to the Service Provider which then may use the token in order to query the at least one Information Source for information. As the Service Provider has used to token to obtain information needed for providing the service, the token becomes invalid. The token can be arranged to be valid for a certain duration in time or to be used for a predetermined number of times.

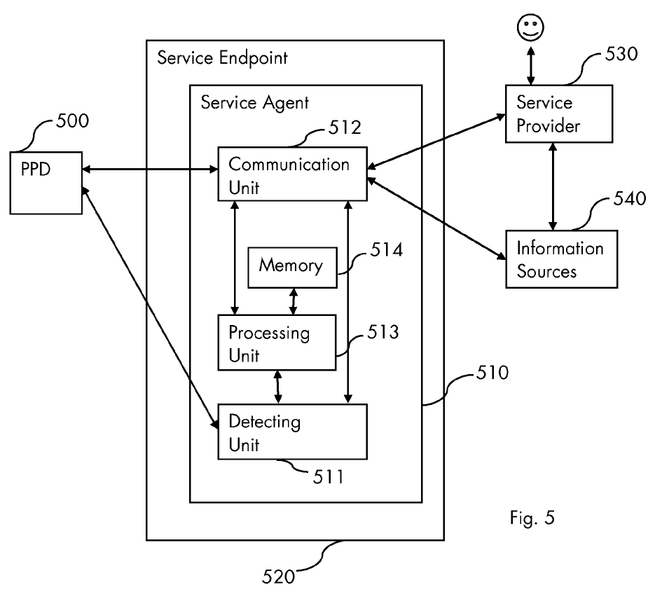

FIG. 5 is a block diagram of an embodiment of a Service Agent adapted to provide a service for a user, e.g. according to any of the procedure described above in relation to FIGS. 1-4.

In the embodiment shown, wherein the Service Agent 510 is incorporated into the Service Endpoint 520, the PDD 500 is being connected to the Service Endpoint. Alternatively, the Service Agent 510 can be implemented as a separate device that is connected to the Service Endpoint 520, wherein the PDD 500 would be connected to the Service Agent 510 which in turn is connected to the Service Endpoint 520.

The Service Agent 510 that is illustrated in FIG. 5 has the same advantages as the method described above. Therefore, the Service Agent will be described only in brief here.

Just to mention a few examples, the Service Endpoint 520 could be a television set at a user's home or in a hotel room, it could be a shared computer at a library, it could be a set-top-box, a game console and so on.

The Service Agent 510 is adapted to provide a service for a user and FIG. 5 illustrates it comprising a detecting unit 511, which is adapted to detect that a PDD 500 is being connected to the Service Agent 510. The PDD is operated by the user.

FIG. 5 also illustrates the Service Agent 510 comprising a communication unit 512, which is adapted to receive a service information message from a Service Provider 530, comprising a service identifier. As was explained above, a user is being given the choice of at least one service that can be delivered to the Service Endpoint, where after the user selects a service giving cause to the information request from the Service Provider 530.

The Service Agent 510 further comprises a processing unit 513, which is adapted to obtain a service profile from the PDD 500, using the service identifier. The processing unit 513 is further adapted to log into at least one Information Source 540 identified from the service profile using personal credentials comprised in the service profile in order to allow the Service Provider 530 to access the information needed for providing the service. The processing unit 513 is further adapted to request the Service Provider 530 to setup a connection to the at least one Information Source 540 to obtain the information needed for providing the service.

In this way, the Service Agent 510 enables the delivery of the service from the Service Provider 530 to the Service Endpoint 520 based on the information that was acquired from the at least one information source.

According to an embodiment, the processing unit 513 is further adapted to retrieve personal settings from the PDD 500 to enable presentation of the service to the user in accordance with the personal settings.

In an example, the service identifier is a Service Type or Service Code.

According to an embodiment, the detecting unit 511 is further adapted to detect disconnection of the PDD 500 from the Service Agent 510, wherein the processing 513 unit is further adapted to request the Service Provider to terminate all connections setup between the Service Agent 510, the Service Provider 530 and the at least one Information Source 540 in association with the delivery of the requested service and to delete all personal information associated with the delivered service in the Service Provider 530. The processing unit 513 is further adapted to log out from the at least one Information Source 540, and to delete all personal information associated with the delivered service in the Service Agent 510. FIG. 5 illustrates the Service Agent 510 comprising a memory 514 in which personal information associated with the delivered service may be stored for the duration of the delivery of the service.

According to yet an embodiment, the communication unit 512 is further adapted to receive a service termination message from the Service Provider 530. As was described above, this is the result of the user wishing to stop making use of the service. Then, the processing unit 513 is adapted to, via the communication unit, request the Service Provider to terminate all connections setup between the Service Agent 510, the Service Provider 530 and the at least one Information Source 540 in association with the delivery of the requested service and to delete all personal information associated with the delivered service in the Service Provider 530. The processing unit 513 is further adapted to log out from the at least one Information Source 540, and to delete all personal information associated with the delivered service in the Service Agent 510.

According to an embodiment, the communication unit 512 is further adapted to receive a service termination message from the Service Provider 530. The processing unit 513 is adapted to start a timer and to detect the lapsing of the timer, wherein the processing unit is further adapted to, via the communication unit, request the Service Provider to terminate all connections setup between said Service Agent, Service Provider and the at least one Information Source in association with the delivery of the requested service and to delete all personal information associated with the delivered service in the Service Provider upon detecting the lapsing of the timer. The processing unit is further adapted to log out from the at least one Information Source and to delete all personal information associated with the delivered service in the Service Agent.

According to an embodiment the processing unit 513 is further adapted to issue a temporary token in response to the reception of the service information message and to provide the token to the Service Provider when requesting the Service Provider to set up a connection to the at least one Information Source, thereby enabling the Service Provider, by means of the token, to obtain the information needed for providing the service.

FIG. 5 also illustrates how the Service Agent 510 interacts with other nodes in order to enable delivery of a service from a service Provider 530 to a Service Endpoint 520. FIG. 5 illustrates an embodiment in which the Service Agent 510 is incorporated into the Service Endpoint 520.

The present invention and its exemplary embodiments can be realized in many ways. For example, an embodiment of the present invention includes a computer-readable medium having program instructions stored thereon that are executable by a computer or processor of the Service Agent to perform the method steps of the exemplary embodiments of the present invention as previously described and as set forth in the claims.

The service profiles may be created in different ways. In one example, wherein the PPD is comprised in a mobile phone, a service profile may be downloaded from an operator. In another example, wherein the PPD is a USB-stick, a service profile may be entered manually from e.g. a computer to which the USB-stick can be inserted, or a profile can be downloaded from a service provider using the computer and then stored on the USB-stick.

As described above, the content on the PPD can be protected by password and it can also be encrypted using common methods. Two examples of encryption methods are Data Encryption Standard (DES) and Advances Encryption Standard (AES). The content can also be protected and accessed by applications on a Universal Integrated Circuit Card (ISCC) used by IP Multimedia Services Identity Module (ISIM) for mobile phones.

In the above described embodiments, the user manually connects the PDD to the Service Agent, either wirelessly of my physical means such as insertion, plug-in and the like. In an embodiment the PDD may scan the radio environment and thereby discover the presence of a service environment. In such a case, a discovery protocol like e.g. Simple Service Discovery Protocol (SSDP) or Universal Plug and Play (UPnP) could be used. The PDD can be adapted to advertise its presence by multicasting a presence message on a specific address and port. The service environment in this example is then adapted to listen on this specific port.

Further, in this example, the PDD is adapted to support at least one Near Field Communication (NFC) technology. Some examples of an NFC technology are Infrared and Bluetooth. The data that is communicated between the PDD and the Service Agent can be exchanged using a secure channel in order to protect user information. The secure channel can be provided by a network protocol such as Secure Shell (SSH).

It is essential that the different entities described above can communicate with each other. When entities communicate, they do so by means of protocols which enable the different entities to “understand” each other. A protocol can be seen as a language that is spoken by the entities involved. The PPD is arranged to have access to a homogeneous language shared by the whole system, which describes the different service types. Such a language can e.g. be described with ontologies. An ontology is a formal representation of knowledge and commonly used in order for different devices to know that they mean the same thing. An example ontology is Dublin Core.

As has been described above, the PPD may hold several different service profiles associated with different services, which services are provided by service providers. A service profile comprises not only identities of information sources which can be accessed to retrieve information and credentials needed to gain access to the information sources, but also description of the language or protocol for the information sources.

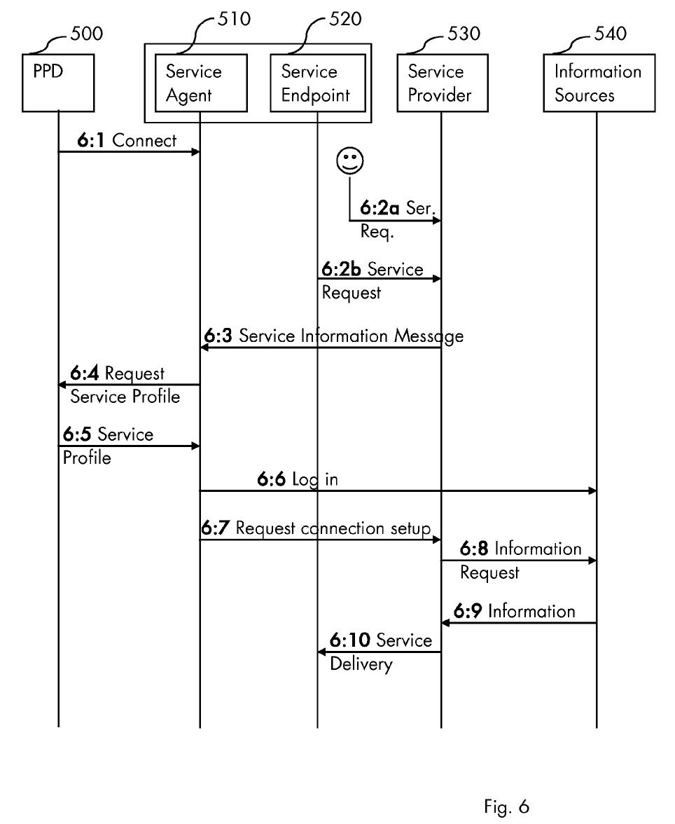

FIG. 6 is a signaling diagram illustrating an embodiment of an exemplary method for providing a service for a user.

In FIG. 6, the Service Agent 510 and the Service Endpoint 520 are illustrated as separate entities. However, the Service Agent can be implemented as a part of, or incorporated into, the Service Endpoint. Such an example is illustrated in FIG. 5 as the Service agent 510 being within the Service Endpoint 520. It is illustrated in FIG. 6 as a dotted line around the Service Agent and the Service Endpoint.

FIG. 6 illustrates the Service Agent 510 detecting 6:1 connection of a PPD 500. The PPD is operated by a user, who e.g. connects the PPD to a Service Agent 510 coupled to a Service Endpoint 520. The PPD has at least one service profile. One example of how this could be done is that the user inserts a USB stick into a television set or the user having his PPD comprised in a mobile phone which detects that a set-top-box is connectable via Bluetooth and establishes a wireless connection to the set-top-box.

The service endpoint may then typically provide information to the user regarding the different services that are supported by or can be delivered to the service endpoint. This will enable the user to select a service. As the user selects a service, a Service Request 6:2a, 6:2b is sent to and received by the Service Provider 530. In alternative 6:2a, the user may enter or give the service request directly to the Service Provider 530, e.g. by sending an SMS to the Service Provider or the like. In alternative 6:2b, the user enters or selects a service by means of the Service Endpoint 520, which forwards the service request to the Service Provider 530. The Service Provider 530 needs personal information regarding the user, i.e. user information, in order to deliver the requested service to the user and requests this information from the Service Agent 510. This is illustrated in FIG. 6 by the Service Agent 510 receiving 6:3 a service information message from a Service Provider 530, comprising a service identifier indicating what information is needed for providing the service.

The Service Agent 510 obtains 6:5 a service profile from the PDD 500, using the service identifier. This is done by the Service Agent 510 sending 6:4 a request for the service profile to the PPD 500, which returns 6:5 the service profile to the Service Agent 510.

When the PPD 500 receives the request for the service profile, the PPD looks at the service identifier and determines which of the at least one service profile that is to be used in relation to the service. If more than one service profile can be used in association with the requested service, the determination of which service profile to use can be done e.g. manually by the user or automatically by the service agent.

As has been described above, the service profile comprises identities of Information Sources which the Service Provider can access, and credentials used to access the Information Source(s).

The Service Agent 510 then logs in 6:6 to at least one Information Source 540 identified from the service profile, using personal credentials comprised in the service profile in order to allow the Service Provider 530 to access the information needed for providing the service. It shall be observed that FIG. 6 is somewhat simplified. In the case of a plurality of Information Sources, step 6:6 is repeated once for every Information Source. In FIG. 6, the Information Source or Information Sources are illustrated by the box 540.

The Service Agent 510 then requests 6:7 the Service Provider 530 to set up 6:8 a connection to the at least one Information Source 540 and to obtain 6:9 the information needed for providing the service. Again, if there is more than one Information Source, these steps are also repeated for every Information Source.

This way, the Service Provider 530 may gain access to the necessary information needed to provide the service to the user, thereby enabling the delivery 6:10 of the service from the Service Provider 530 to a Service Endpoint 520, based on the information retrieved from the at least one Information Sources 540. As has been described above, the Service Endpoint 520 and the Service Agent 510 may be separate entities which are coupled together. Alternatively, the Service Agent 510 may be incorporated into the Service Endpoint 520.

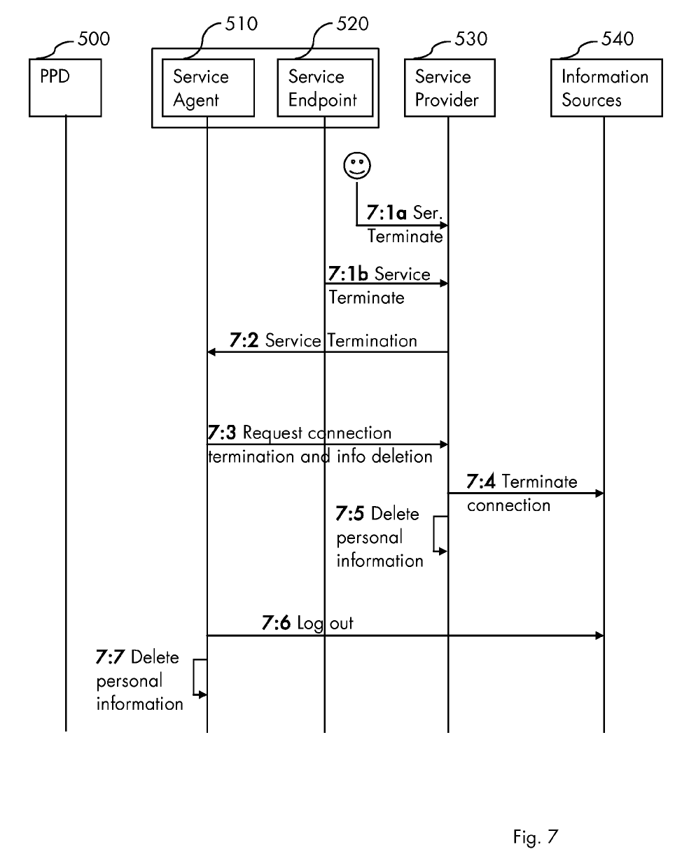

FIG. 7 is a signaling diagram illustrating an embodiment of an exemplary method for providing a service for a user.

In FIG. 7, the Service Agent 510 and the Service Endpoint 520 are illustrated as separate entities. However, the Service Agent can be implemented as a part of, or incorporated into, the Service Endpoint. Such an example is illustrated in FIG. 5 as the Service agent 510 being within the Service Endpoint 520. It is illustrated in FIG. 7 as a dotted line around the Service Agent and the Service Endpoint.

FIG. 7 can be seen as an exemplary continuation of the exemplary method illustrated in FIG. 6. After the user has finished making use of the service, he/she decides to stop using the service. In the example, the user actively gives a “termination order” to the Service Provider as will be described below. As for FIG. 6, FIG. 7 is somewhat simplified. The one or the plurality of Information Sources are illustrated in FIG. 7 as just one entity 540 “Information Sources”. As for FIG. 7, some steps may have to be repeated in the case of more than one Information Source.

As the user wants to stop making use of the service, he/she indicates 7:1a, 7:1b this to the Service Provider 530, optionally via the Service Endpoint 530. As was described above in relation to FIG. 6, the user may enter or give the service termination request 7:1a directly to the Service Provider 530, e.g. by sending an SMS to the Service Provider or the like. In alternative 7:1b, the user enters the service termination request by means of the Service Endpoint 520, e.g. pushing a button, which forwards the service request to the Service Provider 530.

Again with reference to FIG. 7, as the Service Provider 530 receives the request for service termination, the Service Provider 530 informs 7:2 the Service Agent 510 that the user no longer wishes to make use of the service. The Service Agent 510 is then responsible for terminating all connections and deleting all personal information as has been described above. The Service Agent 510 sends 7:3 a request to the Service Provider 530 to terminate all connections setup between the Service Agent 510, the Service Provider 530 and the at least one Information Source 540 in association with the delivery of the requested service and to delete all personal information associated with the delivered service in the Service Provider 530. The Service Provider 530 terminates 7:4 the connections to the Information Sources 540 and deletes 7:5 all user information it has acquired in order to deliver the service to the user. The Service Agent 510 logs out 7:6 from the Information Sources 540 and deletes 7:7 all user information it has acquired associated with the delivered service.

In case of a plurality of Information Sources 540, step 7:3 will be repeated for every Information Source. For every reception of the request 7:3 by the Service Provider, the Service provider will perform steps 7:4 and 7:5. Also step 7:6 will be performed for every Information Source. Alternatively, step 7:3 could be sent once and comprise a request to terminate all connections and to delete all person information in the Service Provider, then the Service Provider will repeat steps 7:4 and 7:5 for every Information Source.

Below, some examples will be described of different services that may be accessed using the Service Agent as has been described above.

One example is a movie recommendation system. In this example, a user is staying at a hotel. He connects his PPD to the TV in the hotel room. The TV in this example comprises a Service Agent and the TV is adapted to being connectable to a PPD. The PPD comprises a service profile for TV channels that the user subscribes to. As the user connects his PPD with the TV in the hotel room, the user will have access to all TV channels that he subscribes to. In other words, the TV in the hotel room will deliver the same TV channels as the user subscribes to at home. The service profile with further comprise identities of information sources which can be accessed in order to obtain user information that might be helpful in order to identify a program on one of the channels, which program might be of interest to the user. The information sources can e.g. be Facebook and Twitter. The service provider for the TV channels accesses the information sources to obtain user information that might be helpful to give personalized recommendations to the user.

Another example is Networked Hard drive access. In this example, a user connects his PPD to a public computer, e.g. in an internet café. The PPD in this example comprises a service profile for the networked hard drive access service. By connecting his PPD to the public computer, the user will gain access to all personal files at a networked storage. Also, the environment, such as the background or screen layout, is displayed in accordance with personal settings stored on the PPD. The personal settings may also give the user access to bookmarks and so on.

Yet another example is Networked Photo frame. A user connects his PPD to a networked photo frame. In this example, the PPD comprises a service profile for the networked photo frame service. As the user connects the PPD to the networked photo frame, personal pictures are available and can be streamed to the photo frame.

In the above examples, as has been previously described, the PPD may be protected such that the user needs to enter a password or some other login or sign-in procedure.

Now, an example will be briefly described. A user called Carol would like to watch a movie but cannot make up her mind about what movie she would like to watch She subscribes to a service called “Recommender Service” which is supported by a Service Provider. This Recommender Service makes use of a person's social relationship, e.g. friends on Facebook. For the Recommender Service to operate, the Service Provider needs to access Carol's account on Facebook in order to query the Application Programming Interface, API. Hence, the Service Provider needs Carol's credentials. In this Example, Carol has a PPD which is incorporated into her mobile telephone. Further, the Service Agent is in this example incorporated into a Set-Top-Box, STB, and the PPD is connected to the STB wirelessly.

The Service Agent in the STB request and receives a service profile from the PPD in the mobile telephone. The service profile indicates that the Information Source to be contacted for this service is Facebook and it also comprises her credentials for Facebook. The Service Agent then logs into Facebook. In this example, Facebook provides the Service Agent with a temporary token which is valid for the duration of the service. The Service Agent requests the Service Provider to setup a connection to Facebook. The Service Provider sets up a connection to Facebook and can obtain personal information, e.g. who her friends are, their favorite groups and so on. Using this information, the Service Provider performs processing of the obtained information in order to recommend movies that Carol might be interested in. The recommendations are presented to Carol who then may choose one of the recommended movies.

After the movie, Carol is hungry and wants a cup of chocolate and a sandwich. She goes to the refrigerator and finds out that she is out of milk. The refrigerator also comprises a Service Agent. The Service agent in the refrigerator is also connected to the PPD in Carol's mobile telephone. The refrigerator also comprises in this example a display and Carol then want to make use of a service for buying groceries, hereinafter referred to as a shopping service. She accesses the shopping service by means of the display. This shopping service is provided by another Service Provider. This Service Provider needs access to Carol's bank. The Service Agent in the refrigerator retrieves a service profile for the shopping service. The profile for the shopping service comprises credentials for Carol's bank. The Service Agent logs into both the bank, which in this example is an Information Source. The Service Agent then requests the Service Provider for the shopping service to setup a connection to the bank. By doing this, the Service Provider can access information, e.g. an account statement, thereby ensuring that Carol has money to shop for. Carol can then order milk from the shopping service.

Another example will now be briefly described. A user called James has his PPD incorporated into a mobile telephone. He subscribes to a service for networked hard drive access. James goes to the library and there he finds a public Personal Computer, PC. The public PC has a Service Agent incorporated into it. This makes is possible for James to connect his PPD to the Service agent in the public PC, by means of wireless connection James needs to access a list of books he is interested in which he has stored in the networked hard drive. He connects his PPD to the Service agent in the public PC and, in the same manner as has been described above, gains access to his list of books stored in the networked hard drive.

It should be noted that FIG. 5 merely illustrates various functional units in the Service Agent in a logical sense. However, the skilled person is free to implement these functions in practice using any suitable software and hardware means. Thus, the invention is generally not limited in the shown structures of the Service Agent and the functional units.

With reference to FIG. 5, the functional units 511-513 described above can be implemented in the Service Agent as program modules of a computer program comprising code means which when run by a processor in the Service Agent causes the Service Agent to perform the above-described functions and actions. The processor may be a single CPU (Central processing unit), or could comprise two or more processing units in the Service Agent For example, the processor may include general purpose microprocessors, instruction set processors and/or related chips sets and/or special purpose microprocessors such as ASICs (Application Specific Integrated Circuit). The processor may also comprise board memory for caching purposes.

The computer program may be carried by a computer program product CPP in the Service Agent connected to the processor. The computer program product comprises a computer readable medium on which the computer program is stored. For example, the computer program product may be a flash memory, a RAM (Random-access memory), a ROM (Read-Only Memory) or an EEPROM (Electrically Erasable Programmable ROM), and the program modules could in alternative embodiments be distributed on different computer program products in the form of memories within the Service Agent.

While the invention has been described with reference to specific exemplary embodiments, the description is generally only intended to illustrate the inventive concept and should not be taken as limiting the scope of the invention. The present invention is defined by the appended claims.

1. A method in a Service Agent for providing a service for a user, the method comprising:
detecting connection of a Personal Profile Device, operated by said user, to said Service Agent,
receiving a service information message from a Service Provider, comprising a service identifier,
obtaining a service profile from said Personal Profile Device, using said service identifier,
logging in to at least one Information Source identified from said service profile using personal credentials comprised in said service profile to allow said Service Provider to access information needed for providing said service, and
requesting said Service Provider to set up a connection to said at least one Information Source and to obtain the information needed for providing said service, to enable delivery of said service from said Service Provider to a Service Endpoint operatively connected to said Service Agent, based on said information needed for providing said service.

2. A method according to claim 1, further comprising retrieving personal settings from said Personal Profile Device to enable presentation of said service via said Service Endpoint in accordance with said personal settings.

3. A method according to claim 1, wherein said service identifier is a Service Type or a Service ID.

4. A method according to claim 1, further comprising:
detecting disconnection of said Personal Profile Device from said Service Agent,
requesting said Service Provider to terminate all connections set up between said Service Agent, said Service Provider and said at least one Information Source in association with the delivery of the requested service and to delete all personal information associated with said delivered service in said Service Provider; logging out from said at least one Information Source, and deleting all personal information associated with said delivered service in said Service Agent.

5. A method according to claim 1, further comprising:
receiving a service termination message from said Service Provider,
requesting said Service Provider to terminate all connections set up between said Service Agent, said Service Provider and said at least one Information Source in association with the delivery of the requested service and to delete all personal information associated with said delivered service in said Service Provider; logging out from said at least one Information Source, and deleting all personal information associated with said delivered service in said Service Agent.

6. A method according to claim 1, further comprising:
receiving a service termination message from said Service Provider,
starting a timer, and; when said timer has lapsed, the method comprises requesting said Service Provider to terminate all connections set up between said Service Agent, said Service Provider and said at least one Information Source in association with the delivery of the requested service and to delete all personal information associated with said delivered service in said Service Provider; logging out from said at least one Information Source, and deleting all personal information associated with said delivered service in said Service Agent.

7. A method according to claim 1, further comprising establishing a secure communication channel between said Personal Profile Device and said Service Agent after detection of connection of said Personal Profile Device to said Service Agent.

8. A method according to claim 1, further comprising issuing a temporary token in response to receiving said service information message and providing said temporary token to said Service Provider when requesting said Service Provider to set up a connection to said at least one Information Source, to enable said Service Provider, by use of the temporary token, to obtain the information needed for providing said service.

9. A Service Agent adapted to provide a service for a user, comprising:
a detecting unit adapted to detect connection of a Personal Profile Device, operated by said user, to said Service Agent,
a communication unit, adapted to receive a service information message from a Service Provider, comprising a service identifier, and
a processing unit adapted to, via said communication unit:
obtain a service profile from said Personal Profile Device, using said service identifier,
log in to at least one Information Source identified from said service profile using personal credentials comprised in said service profile in order to allow said Service Provider to access the information needed for providing said service, and
request said Service Provider to set up a connection to said at least one Information Source to obtain the information needed for providing said service, to enable the delivery of said service from said Service Provider to a Service Endpoint operatively connected to said Service Agent, based on said information needed for providing said service.

10. A Service Agent according to claim 9, wherein said processing unit is further adapted to retrieve personal settings from said Personal Profile Device to enable presentation of said service via said Service Endpoint in accordance with said personal settings.

11. A Service Agent according to claim 9, wherein said service identifier is a Service Type or Service ID.

12. A Service Agent according to claim 9, wherein said detecting unit is further adapted to:
detect disconnection of said Personal Profile Device from said Service Agent,
request said Service Provider to terminate all connections set up between said Service Agent, Service Provider and said at least one Information Source in association with the delivery of the requested service; to delete all personal information associated with said delivered service in said Service Provider; to log out from said at least one Information Source, and to delete all personal information associated with said delivered service in said Service Agent.

13. A Service Agent according to claim 9, wherein said communication unit is further adapted to:
receive a service termination message from said Service Provider,
request said Service Provider to: terminate all connections set up between said Service Agent, Service Provider and said at least one Information Source in association with the delivery of the requested service; to delete all personal information associated with said delivered service in said Service Provider; to log out from said at least one Information Source, and to delete all personal information associated with said delivered service in said Service Agent.

14. A Service Agent according to claim 9, wherein said communication unit is further adapted to receive a service termination message from said Service Provider, wherein said processing unit is adapted to start a timer, the processing unit further being adapted to detect the lapsing of said timer, wherein the processing unit further is adapted to request said Service Provider to: terminate all connections set up between said Service Agent, Service Provider and said at least one Information Source in association with the delivery of the requested service; to delete all personal information associated with said delivered service in said Service Provider; to log out from said at least one Information Source, and to delete all personal information associated with said delivered service in said Service Agent.

15. A Service Agent according to claim 9, wherein said communication unit further is adapted to establish a secure communication channel between said Personal Profile Device and said Service Agent after detection of connection of said Personal Profile Device to said Service Agent.

16. A Service Agent according to claim 9, wherein said processing unit further is adapted to issue a temporary token in response to the reception of said service information message and to provide said temporary token to said Service Provider when requesting said Service Provider to set up a connection to said at least one Information Source, thereby enabling said Service Provider, by use of the temporary token, to obtain the information needed for providing said service.

17. A Service Agent according to claim 9, wherein said Service Agent is incorporated into said Service Delivery Endpoint.

18. A Service Endpoint comprising a Service Agent according to claim 9.

19. A service Endpoint according to claim 18, being any of a: Set Top Box, Television set, Mobile telephone, computer, Personal Digital Assistant, game console.

20. A computer-readable medium comprising a computer program having program instructions stored thereon that are executable by a computer or processor of the Service Agent according to claim 9, to perform the method steps according to claim 1.
